(19) United States
(12) Patent Application Publication
(10) Pub. No.: US 2004/0235612 A1
(43) Pub. Date: Nov. 25, 2004

(54) Toroidal gearbox with adjuster device

(76) Inventors: Stephan Stroph, Tettnang (DE); Jurgen Wafzig, Eriskirch (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/489,929

(22) PCT Filed: Aug. 30, 2002
(86) PCT No.: PCT/EP02/09714

(30) Foreign Application Priority Data
Sep. 29, 2001 (DE) 101 48 399.6

(51) Int. Cl. F16H 15/38

(52) U.S. Cl. 476/46

(57) ABSTRACT

A continuously variable toroidal transmission comprising at least one input disc and at least one output disc has several friction wheels (10, 19′, 10″) between the inner surfaces of the input and output discs, on pivoting bodies (2, 2′, 2″) of a support element (1), retained by wheel carriers (9, 9′, 9″) and pivotally supported. The wheel carriers (9, 9′, 9″) of the friction wheels (10, 10′, 10″) are connected with the pivoting bodies (2, 2′, 2″) by one coupling element (19). The coupling element (19) has a ball guide (25) with a longitudinal hole (22) for movement in linear direction along the axis of the appertaining wheel carrier (9, 9′, 9″).

According to the preamble of claim 1, the invention relates to a toroidal transmission, particularly a toroidal transmission in three-roller design.

Such a toroidal transmission usually has input and output discs coaxial with a common shaft which are disposed in pairs having their inner surfaces toroidally configured and friction wheels located between the pairs of input and output discs. The friction wheels are in frictional contact both with the input discs and with the output discs and by frictional contact transmit to the output disc the torque transmitted to them by the input discs. The rotational speed of the friction wheels is higher the larger the distance between the contact point with the input disc and the axis of rotation. The rotational speed of the output disc, on the other hand, is higher the closer the contact point between the friction wheel and the output disc to the axis of rotation. By pivoting the friction wheels, it is accordingly possible to adjust the rotational speed of the output disc to continuously variable and arbitrarily. To this end, the axes of rotation of the friction wheels are supported on a carrier which can be controlled via an adjusting device.

Toroidal transmission in three-roller design are at present widely used since, by increasing the number of friction rollers, the load upon each individual friction roller can be reduced. For this purpose, there are provided three friction wheels, between the input and the output disc, supported by wheel carriers. Three Y-shaped pivoting bodies are rotatably supported upon a three-membered star connected with a housing of the transmission. Each one of the wheel carriers is coupled with two pivoting bodies, i.e., it is movably connected by one end to one arm of a first pivoting body and by the other end to one arm of a second pivoting body. A change to a desired reduction ratio is introduced by pivoting the pivoting bodies whereby the wheel carriers are tilted and the friction wheels incline relative to the input and output discs.

A hydraulic system can be used to control the friction wheels. For this purpose, each wheel carrier is connected with a hydraulic piston which can be adjusted, via a hydraulic system, so that a force is exerted upon the carriers and an inclination of a friction wheel can be produced.

In conventional toroidal transmissions, the friction wheels are each supported in the wheel carriers by support shafts. At the same time, each one of the support shafts projects into a central hole made in the respective friction wheel and has an eccentric area which projects into a hole made in the respective wheel carrier. Needle bearings are provided for the radial support of the support shaft in the area of the central hole and in the eccentric area. Ball bearings are situated in the outer area of the friction wheels for absorbing a radially outwardly oriented pressure along the support shaft.

Due to the strong adjusting torques when changing the rotational speed ratios to the strong contact pressures needed for transmitting the torques and to the elasticity of the parts used, strict requirements are imposed on the connection between the wheel carriers and the pivoting bodies. One part of the required compensation movement can be produced via the eccentric and the needle bearing of the wheel carrier or by the pivotal connection of the pivoting bodies. But one other part must be produced by the support of the wheel carrier on the pivoting body.

DE 44 44 952 C2, for example, has disclosed one toroidal transmission having three driving rollers which are grouped around a main shaft at equal initial distances relative to each other and are rotatably supported by roller support bodies. The roller support bodies are made so as to extend in direction along their own pivot axes. Each one of the pivot axes is perpendicular to the axis of rotation of a corresponding driving roller. Adjacent ends of the three roller support bodies are respectively interconnected by L-shaped coupling elements and this specifically rotatably and tiltably via ball joints. Each coupling element is rotatably supported in its central section on an intermediate section of a corresponding arm of a common star-shaped coupling support element. The coupling support element is secured to the transmission housing.

EP 0 413 347 B1 shows a toroidal transmission having three peripherally spaced friction rollers situated between the toric surfaces of the input and output discs and in driving contact therewith. The friction rollers are supported by roller carriers disposed on pivoting bodies which are rotatably supported in the housing. Each one of the pivoting bodies has two arms, each arm being coupled with one of the adjacent roller carriers. For this purpose, a vaulted ring is placed between the front end area of the roller carrier and the wall of a hole made in the adjacent arm of an appertaining pivoting body. Thereby a pivoting connection results between the arm of the pivoting body and the appertaining roller carrier. Between the inner periphery of the vaulted ring and the end area of the roller carrier, one needle bearing is situated to make a sliding motion of the roller carrier possible. Thereby a movable connection results between each one of the arms and the appertaining roller carriers.

The problem on which this invention is based is to provide a toroidal transmission in which the connection between frictional wheel carrier and pivoting body allows an improved compensating motion for the engaging forces and which needs few parts, lengthens the service life of the parts and is economical to produce.

Departing from a toroidal transmission of the type specifically mentioned above, said problem is solved with the features stated in claim 1.

It is provided, according to the invention, that the wheel carriers of the friction wheels be connected by a coupling element with the pivoting bodies. The coupling element has a ball guide with a longitudinal hole to make a motion in linear direction possible along the axis of the appertaining wheel carrier.

By virtue of the inventive coupling element, a compensating movement results linearly along the axis of a wheel carrier and not upon a curved path which would result from an eccentric mounting of the friction wheels. Instabilities in the adjusting behavior can be prevented thereby. The eccentric and the appertaining needle case in the wheel carriers are no longer required. Parts and working steps can be spared whereby the costs for the toroidal transmission are reduced. Altogether thestability of the adjusting behavior of the transmission increases.

In a preferred embodiment of the invention, the coupling element is employed in a toroidal transmission in three-roller design. The inventive coupling element can also be used in this type of transmission where the friction wheels are disposed relative to each other forming an angle of about 120°.

As described above, the deviation movement of the friction wheels is primarily synchronized via the hydraulic device. A secondary synchronization can be accomplished in the instant invention by the coupling elements, via bolts, which are laterally pressed against the surface of the longitudinal hole with positive engagement.

By virtue of the inventively provided longitudinal holes in the coupling elements, tolerances resulting by manufacturing and assemblage can be compensated.

The invention is explained in detail herebelow with reference to the drawing. The drawing shows:

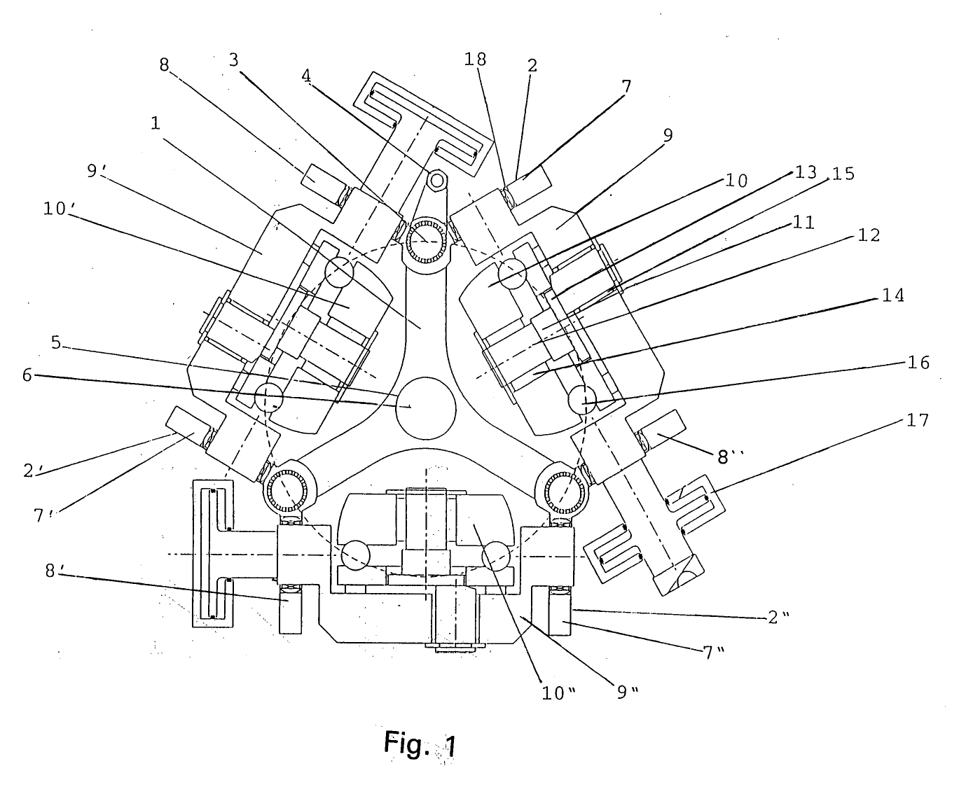

FIG. 1 is a cutaway view of a toroidal transmission according to the prior art;

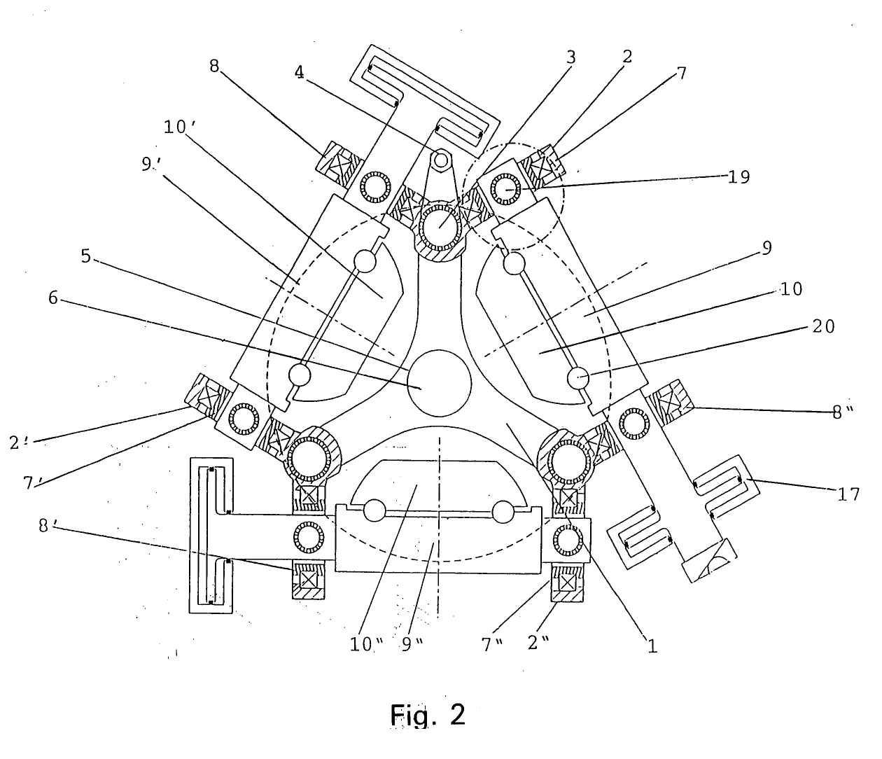

FIG. 2 is a cutaway view of a toroidal transmission according to the instant invention; and

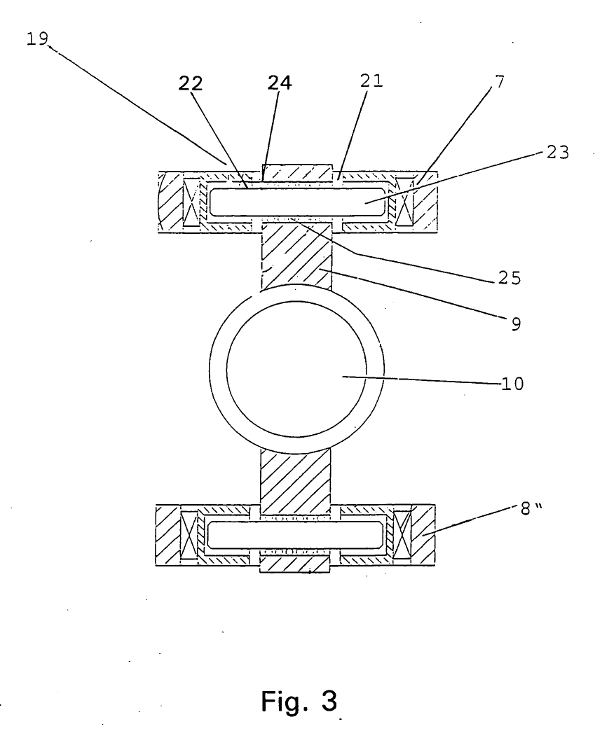

FIG. 3 is a section through a detailed view of a coupling element according to the instant invention.

FIG. 1 shows a toroidal transmission in a three-roller design according to the prior art. The transmission has coaxial input and output discs with toric surfaces. The discs are diagrammatically shown by dotted line.

On a star-shaped support element 1, three V-shaped pivoting bodies 2, 2′ and 2″ are situated by guide axis 3. In the area of one guide axis 3, the star-shaped support element 1 is fastened on the housing of the transmission by a screw 4. A disc support shaft 6 extends through a central opening 5 of the support element 1. Each one of the V-shaped pivoting bodies 2, 2′ and 2″ has two arms 7, 7′, 7″ and 8, 8′, 8″. Between pivoting bodies, adjacent respectively to two arms, wheel carriers 9, 9′ and 9″ are situated which support friction wheels 10, 10′and 10″. The wheel carrier 9, for example, is mounted between the arm 7 of the pivoting body 2 and the arm 8″ of the pivoting body 2″.

The friction wheel 10 is situated on the wheel carrier 9 by a support shaft 11. The support shaft 11 is passed through a central hole 12 into the friction wheel 10 and through an eccentric hole 13 into the wheel carrier 9. Between the support shaft 11 and the friction wheel 10, one needle bearing 14 is provided in the central hole 12 and between the support shaft 11 and the wheel carrier 9, one needle bearing 15 is provided in the eccentric hole 13. The friction wheel 10 has, on the edge for support, one ball bearing 16. The two other friction wheels 10′ and 10″ are analogously disposed between the arms 7′ and 8 or the arms 7″ and 8′ of the corresponding pivoting body. During a movement of the wheel carrier 9, 9′ and 9″ in a peripheral direction of the input and output discs, the wheel carriers 9, 9′ and 9″ are tilted with the result of an inclination of the friction wheels 10, 10′ and 10″ against the input and output discs.

Each one of the wheel carriers 9, 9′ and 9″ has one hydraulic piston 17 which in radial direction is situated on one side opposite the arms 8, 8′ and 8″. The hydraulic piston 17 of the wheel carrier 9 located on one side of the arm 8″ of the pivoting body 2″ is, for example, provided upon the opposite other side of the arm 8″. The hydraulic pistons are controlled, via a hydraulic device, in order to achieve a continuously variable ratio change through the toroidal transmission.

In the arms 7, 7′, 7″ and 8, 8′ and 8″ of the pivoting bodies 2, 2′ and 2″, holes 18 are provided which accommodate the wheel carrier 9, 9′ and 9″. To form and adjustable connection, there was used in the prior art, for example, one needle bearing or one ball bearing.

In FIG. 2 is shown a continuously variable toroidal transmission according to the instant invention. Parts coinciding with the ones previously described are provided with the same reference numerals. On a star-shaped support element 1, three pivoting bodies 2, 2′ and 2″ are situated between whose arms 7, 7′, 7″ and 8, 8′ 8″ friction wheels 10, 10′ and 10″ are disposed on wheel carriers 9, 9′ and 9″. The wheel carriers 9, 9′ and 9″ are adjustably arranged by inventive coupling elements 19 on the arms of the pivoting bodies. By using said coupling elements, a support shaft 11, such as provided in FIG. 1 in the prior art, no longer is needed for support of the friction wheels. In the instant invention, the friction wheels 10, 10′ and 10″, for example, are movably situated on their respective wheel carriers 9, 9′ and 9″, by roller bearings 20. Thereby parts can be spared and the production simplified.

The connection of the arms of the pivoting bodies with the wheel carriers by the inventive coupling element is shown, in detail, in a part view in FIG. 3. The arms of the respective pivoting body are designated with 7 and 8″ which support the wheel carrier 9 with the friction wheel 10. The coupling element 19 has one hole through the arm 7 of the pivoting body into which extends the wheel carrier 9. With in the arm of the pivoting body, one longitudinal hole 22 is provided which extends in longitudinal direction of the arm. One bolt 23 extends through a hole 24 in the end area of the wheel carrier and is additionally supported within the longitudinal hole 22. Within the hole 24 in the wheel carrier 9 the bolt 23 is movably disposed by a ball guide 25. Besides, the bolt 23 is supported within the longitudinal hole 22 on the sides by the walls of the longitudinal hole but is upwardly and downwardly movable. The carrier 9 is analogously mounted on the arm 8″.

By virtue of the lateral conduction of the bolt on the surfaces of the longitudinal holes, it is possible to synchronize the deviation of the friction wheels for control via the hydraulic device. With the aid of the play provided by the longitudinal holes, a compensating motion can result in linear direction axially with the wheel carriers. By the coupling element of the instant invention, the stability of the adjusting behavior of the toroidal transmission can be altogether clearly improved.

### Reference Numerals

1 star-shaped support element

2,2′2″ pivoting body

3 guide axis

4 screw

5 central opening

6 disc support shaft

7, 7′, 7″ arm of the pivoting body

8, 8′, 8″ arm of the pivoting body

9, 9′, 9″ wheel carrier

10, 10′, 10″ friction wheels

11 support shaft

12 central hole of support shaft

13 eccentric hole

14 needle bearing

15 needle bearing

16 ball bearing

17 hydraulic piston

18 hole

19 coupling element

20 ball bearing

21 hole

22 longitudinal hole

23 bolt

24 hole

25 ball guide

1-4. (CANCELED)

5. A continuously variable toroidal transmission comprising
an input shaft (6) coaxially with which at least one toroidal input disc and at least one toroidal output disc are disposed, there being pivotally supported between the inner surfaces of said input and output discs, on pivoting bodies (2, 2, 2″) of a support element (1), several friction wheels (10, 10′, 10″) held by wheel carriers (9, 9′, 9″) and said pivoting bodies have one adjusting device for transmitting a torque from said input disc to said output disc by the friction wheels,
wherein said wheel carriers (9, 9′, 9″) of said friction wheels (10, 10′,10″) are connected with said pivoting bodies (2, 2′, 2″) by one coupling element (19), said coupling element (19) having a ball guide (25) with a longitudinal hole (22) for movement in linear direction along an axis of the appertaining wheel carrier (9, 9′, 9″) for performing a compensation movement along the axis.

6. The toroidal transmission according to claim 5, wherein said coupling element (19) can be used in a toroidal transmission in three-roller design.

7. The toroidal transmission according to claim 5, wherein a hydraulic device (17) is provided for synchronizing a deviation movement of said friction wheels (9, 9′, 9″).

8. The toroidal transmission according to claim 5, wherein in the coupling elements (19), bolts (23) are provided which can be laterally pressed against a surface of said longitudinal holes (22) for synchronization.
